(19) United States
(12) Patent Application Publication
(10) Pub. No.: US 2026/0119924 A1
(43) Pub. Date: Apr. 30, 2026

(54) ARTIFICIAL INTELLIGENCE (AI) SYSTEMS WITH COGNITIVE OBSERVABILITY FOR REASONING OF FOUNDATION MODEL-POWERED AGENTS, AND APPARATUSES, METHODS, AND NON-TRANSITORY COMPUTER-READABLE STORAGE MEDIA THEREFOR

(71) Applicant: HUAWEI TECHNOLOGIES CO., LTD., Shenzhen (CN)

(72) Inventors: Benjamin Rombaut, Montreal (CA); Sogol Masoumzadeh, Kingston (CA); Kirill Vasilevski, Toronto (CA); Dayi Lin, Toronto (CA); Ahmed E. Hassan, Kingston (CA)

(21) Appl. No.: 19/328,336

(22) Filed: Sep. 15, 2025

Related U.S. Application Data
(60) Provisional application No. 63/714,482, filed on Oct. 31, 2024.

(51) Int. Cl. G06N 5/043

(52) U.S. Cl. CPC G06N 5/043

(57) ABSTRACT

A computerized method for generating reasoning of a first agent of a foundation model (FM). The computerized method has the step of: using a second agent to replicate a first completion generated by the first agent corresponding to a prompt while reasoning a thought process of the first agent in generating the first completion from the prompt, for generating the reasoning of the first agent.

### CROSS-REFERENCE TO RELATED APPLICATIONS

This application claims the benefit of U.S. Provisional Patent Application Ser. No. 63/714,482, filed Oct. 21, 2024, the content of which is incorporated herein by reference in its entirety.

### FIELD OF THE DISCLOSURE

The present disclosure relates generally to artificial intelligence (AI) systems, and apparatuses, methods, and computer-readable storage media therefor, and in particular to AI systems with cognitive observability for reasoning of foundation model-powered agents, and apparatuses, methods, and non-transitory computer-readable storage media therefor.

### BACKGROUND

Foundation models (FMs) or language models (LMs) such as large language models (LLMs) are neural network models that may learn the semantics and syntax of language by encoding (sub) words into vector representations. Foundation models have been used in various artificial intelligence (AI) applications such as generative AI systems.

Agentic software (that is, agentware), powered by FMs with reasoning capabilities, are gaining significant traction in a variety of domains such as autonomous software development, customer support, data analytics, and/or the like. However, such agentic software presents new challenges compared to traditional software, especially in the realm of observability, as they operate with high levels of autonomy and unpredictability, and make decisions through implicit reasoning that is often opaque. This opacity complicates the ability to monitor, debug, and ensure the reliability of such software. For instance, an FM-powered applicant recommendation system has been found to manifest biases towards certain applicants based on their specific traits. Despite significant efforts, engineers are often not able to identify the root causes of these inherited biases due to the “black-box” nature of the reasoning behind such agentic software.

### SUMMARY

According to one aspect of this disclosure, there is provided a computerized method for generating reasoning of a first agent of a foundation model (FM), the method comprising: using a second agent to replicate a first completion generated by the first agent corresponding to a prompt while reasoning a thought process of the first agent in generating the first completion from the prompt, for generating the reasoning of the first agent.

In some embodiments, the second agent is same as or equivalent to the first agent.

In some embodiments, the second agent has a same or equivalent configuration as the first agent.

In some embodiments, said using the second agent to replicate the first completion generated by the first agent corresponding to the prompt while reasoning the thought process of the first agent in generating the first completion from the prompt comprises: using the second agent to generate the reasoning of the first agent based on the prompt and the first completion; and verifying consistency of the generated reasoning of the first agent.

In some embodiments, said using the second agent to generate the reasoning of the first agent based on the prompt and the first completion comprises: using the second agent to generate one or more reasoning paths as the reasoning of the first agent, based on the prompt and the first completion.

In some embodiments, using the second agent to generate the one or more reasoning paths as the reasoning of the first agent comprises: using the second agent to use a Fill-in-the-Middle (FIM) method to generate the one or more reasoning paths as the reasoning of the first agent, based on the prompt and the first completion; wherein an input of the FIM method has a prefix-middle-suffix structure, and comprises the prompt as a prefix and the first completion as a suffix, and each middle generated by the FIM method is one of the one or more reasoning paths.

In some embodiments, using the second agent to generate the reasoning of the first agent based on the prompt and the first completion comprises: using the second agent to generate one or more chain-of-thought reasonings as the generated reasoning of the first agent based on the prompt; wherein each of the one or more chain-of-thought reasonings leads to an answer matching the completion of the first agent.

In some embodiments, said using the second agent to generate the one or more chain-of-thought reasonings as the generated reasoning of the first agent based on the prompt comprises: using the second agent to generate a plurality of reasonings; and selecting one or more of the plurality of reasonings that match the completion of the first agent.

In some embodiments, said verifying the consistency of the generated reasoning of the first agent comprises: extracting consistent threads and/or recurring ideas from the generated reasoning of the first agent; and verifying alignment between the extracted threads and ideas and the prompt.

In some embodiments, said verifying the alignment between the extracted threads and ideas and the prompt comprises: calculating an importance of each of one or more attributions of the prompt in influencing the first completion; and validating that extracted threads and/or ideas comprise one or more of the attributions of the prompt whose importance is greater than a predefined threshold.

In some embodiments, said calculating the importance of each of the one or more attributions of the prompt in influencing the first completion comprises: (i) tokenizing the prompt to obtain a tokenized prompt having a plurality of tokens; for each of the plurality of tokens of the tokenized prompt: (ii-1) removing the token from the tokenized prompt to obtain a perturbed prompt, (ii-2) using the first agent to generate a second completion based on the perturbed prompt, (ii-3) calculating probability differences among analogous tokens of the second completion and the first completion, (ii-4) repeating steps (ii-2) and (ii-3) for one or more times, and (ii-5) calculating an average of the calculated probability differences as the importance of the removed token.

According to one aspect of this disclosure, there is provided a system comprising: one or more non-transitory, computer-readable storage media; and one or more processors functionally connected to the one or more non-transitory, computer-readable storage media; wherein the one or more non-transitory, computer-readable storage media comprising computer-executable instructions; and wherein the instructions, when executed, cause the one or more processors to perform any of the above-described methods and/or any of the methods disclosed herein.

According to one aspect of this disclosure, there is provided an apparatus comprising one or more processors functionally connected to one or more memories storing instructions; the one or more processors are configured to execute the instructions to perform any of the above-described methods and/or any of the methods disclosed herein.

According to one aspect of this disclosure, there is provided one or more memories storing instructions; the instructions, when executed, cause one or more processors to perform any of the above-described methods and/or any of the methods disclosed herein.

In another aspect, embodiments of this disclosure provide an apparatus, wherein the apparatus comprises a function or unit to perform any of the above-described methods and/or any of the methods disclosed herein.

In another aspect, embodiments of this disclosure provide a computer readable storage medium, comprising one or more instructions, wherein when the one or more instructions are run on a computer, the computer performs any of the above-described methods and/or any of the methods disclosed herein.

In another aspect, embodiments of this disclosure provide a non-transitory computer-readable medium storing instruction the instructions causing a processor in a device to implement any of the above-described methods and/or any of the methods disclosed herein.

In another aspect, embodiments of this disclosure provide a device configured to perform any of the above-described methods and/or any of the methods disclosed herein.

In another aspect, embodiments of this disclosure provide a processor, configured to execute instructions to cause a device to perform any of the above-described methods and/or any of the methods disclosed herein.

In another aspect, embodiments of this disclosure provide an integrated circuit configure to perform any of the above-described methods and/or any of the methods disclosed herein.

According to one aspect of this disclosure, there is provided a module comprising: one or more circuits for performing any of the above-described methods and/or any of the methods disclosed herein.

According to one aspect of this disclosure, there is provided one or more processors functionally connected to one or more memories for performing any of the above-described methods and/or any of the methods disclosed herein.

According to one aspect of this disclosure, there is provided an apparatus comprising: one or more processors functionally connected to one or more memories for performing any of the above-described methods and/or any of the methods disclosed herein.

According to one aspect of this disclosure, there is provided an apparatus configured to perform any of the above-described methods and/or any of the methods disclosed herein.

In some embodiments the apparatus comprises one or more units configured to perform any of the above-described methods and/or any of the methods disclosed herein.

According to one aspect of this disclosure, there is provided one or more non-transitory, computer-readable storage media comprising computer-executable instructions, wherein the instructions, when executed, cause at least one processing unit, at least one processor, or at least one circuits to perform any of the above-described methods and/or any of the methods disclosed herein.

According to one aspect of this disclosure, there is provided one or more computer-readable storage media storing a computer program, wherein, when the computer program is executed by an apparatus, the apparatus is enabled to implement any of the above-described methods and/or any of the methods disclosed herein.

According to one aspect of this disclosure, there is provided a computer program product including one or more instructions, wherein, when the instructions are executed by an apparatus, the apparatus is enabled to implement any of the above-described methods and/or any of the methods disclosed herein.

According to one aspect of this disclosure, there is provided a computer program, wherein, when the computer program is executed by a computer, an apparatus is enabled to implement any of the above-described methods and/or any of the methods disclosed herein.

According to one aspect of this disclosure, there is provided a system comprising a node for performing any of the above-described methods and/or any of the methods disclosed herein.

According to one aspect of this disclosure, there is provided an apparatus for implementing any of the above-described methods and/or any of the methods disclosed herein in any possible implementation of the foregoing aspects.

In various embodiments, the above-described methods and/or the methods disclosed herein (denoted “disclosed methods”) provide various benefits.

For example, by using the reasoning observability method, the disclosed methods introduce a novel technique for observing an agent's implicit reasoning process.

The disclosed methods provide non-intrusive reasoning observation. The second agent (denoted the “surrogate agent”) operates in parallel to the first agent (denoted “primary agent”), mimicking its behavior but also generating a verbose reasoning process. This setup isolates the reasoning process from the actual task completion. Since the primary agent is unaware of the surrogate agent's role and continues to operate normally, its output remains unchanged. Thus, the technique allows us to observe reasoning without any interference with the original output.

The disclosed methods provide consistency and fidelity. The surrogate agent decouples reasoning from the FM's output, allowing the primary agent to produce its strictly formatted completion as required by downstream systems. Meanwhile, the surrogate agent performs a reasoning process independently, capturing the implicit decision-making path without integrating reasoning into the primary agent's output. This ensures that the primary agent continues to meet the strict formatting demands while the reasoning is still observable in parallel.

The disclosed methods provide enhanced debugging and interpretability. The disclosed methods enable enhanced observability by providing verbose reasoning paths, which can help in debugging, analyzing, and improving the primary agent's performance without modifying the underlying task completion.

In various embodiments, the disclosed methods may use various methods to reasoning generation by capturing the implicit reasoning of the primary agent with exploration of FIM capabilities or without relying on FIM capabilities. Moreover, some methods used in the disclosed methods may prompt the surrogate agent to explicitly generate chain-of-thought reasoning while ensuring alignment with the primary agent's completion.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM);

FIGS. 5A to 5C are schematic diagrams showing different types of the LLMs shown in FIG. 4, wherein

FIG. 5A is a schematic diagram showing an encoder-based LLM,

FIG. 5B is a schematic diagram showing a decoder-based LLM, and

FIG. 5C is a schematic diagram showing an encoder-decoder-based LLM;

FIG. 6 is a schematic diagram showing an example of an AI system in the form of an agentware using three agents to automate the process of turning human ideas into software systems;

FIG. 7 is a schematic diagram showing a cognitive observability method for generating reasoning of an agent, according to some embodiments of this disclosure; and

FIG. 8A is a schematic diagram showing a cognitive observability method using a repetitive chain-of-thought (RepCoT) method for generating reasoning of an agent, according to some embodiments of this disclosure; and

FIG. 8B a schematic diagram showing the details of FIG. 8A.

### DETAILED DESCRIPTION

Embodiments disclosed herein relate to artificial intelligence (AI) judge systems employing search-driven constitution-based framework, and apparatuses, methods, and non-transitory computer-readable storage media therefor. The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### A. System Structure

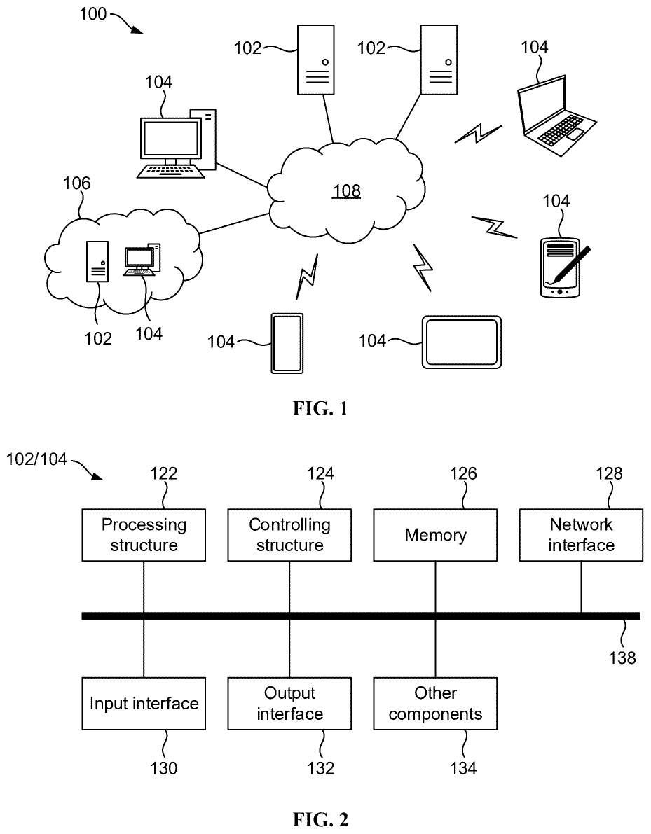

Turning now to FIG. 1, a computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as laptop computers, tablets, smartphones, Personal Digital Assistants (PDAs), desktop computers, and/or the like. Each client computing device 104 may execute one or more client application programs which sometimes may be called “apps”.

Generally, the computing devices 102 and 104 comprise similar hardware structures such as hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “O” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled in the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device 102/104.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screen, touch-sensitive whiteboard, touch-pad, keyboards, computer mouse, trackball, microphone, scanners, cameras, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementation, may be integrated with a display output to form a touch-sensitive screen or touch-sensitive whiteboard.

The output interface 132 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

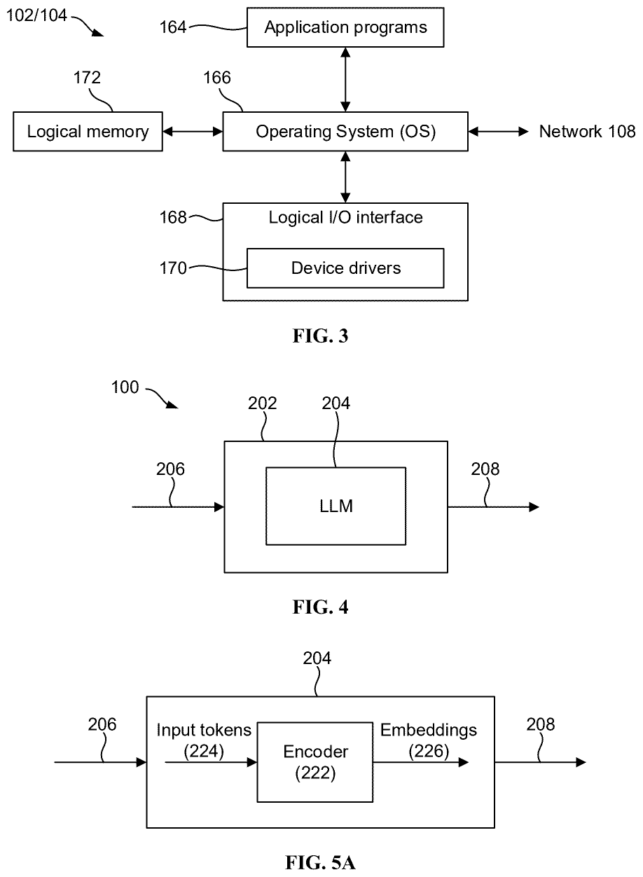

FIG. 3 shows a simplified software architecture of the computing device 102 or 104. On the software side, the computing device 102 or 104 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Cognitive Observability Methods for Reasoning of Foundation Model-Powered Agents

In some embodiments, the computer network system 100 executes an artificial intelligence (AI) engine (for example, in the form of one or more software programs). As shown in FIG. 4, the AI engine 202 comprises a foundation model (FM) such as a LLM 204 (which is used as an example in the following description), for processing input 206 (also called “prompt”; for example, natural language input in the form of text, voice, images, and/or the like), recognizing and interpreting the input 206 for generating the output 208 in suitable forms (for example, in form of text, image, audio, video, and/or the like) as the response to the prompt 206. As those skilled in the art will appreciate, foundation models such as LLMs are neural network models that learn the semantics and syntax of language by encoding (sub) words into vector representations.

Using LLMs as an example, LLMs use transformer models and are trained using massive datasets. Current LLMs such as Chat-GPT, GPT-4, LLAMA, and PaLM2 have proven to achieve state-of-the-art (SOTA) performance in various natural language processing (NLP) tasks.

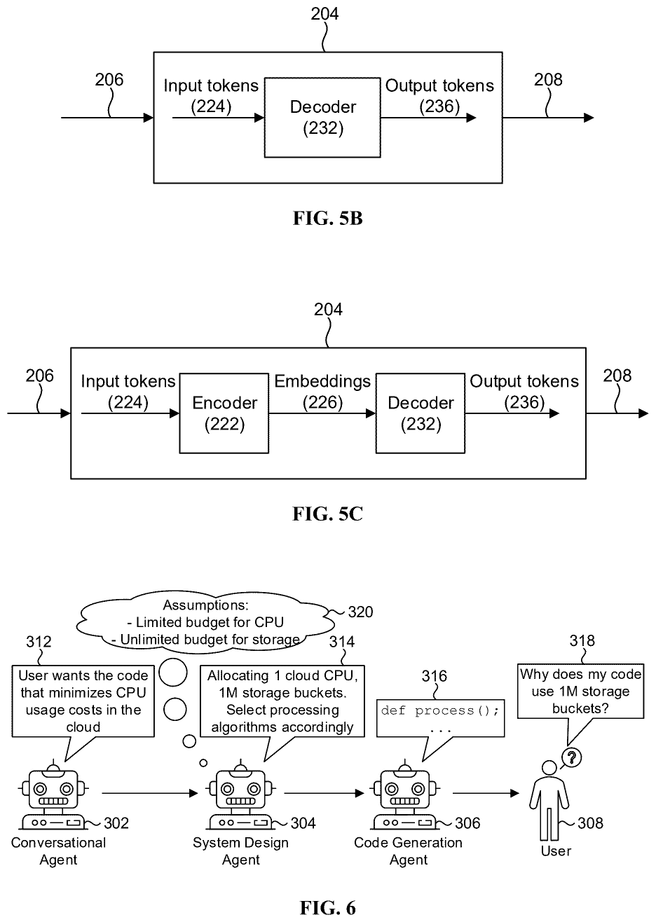

FIGS. 5A to 5C are schematic diagrams showing different types of LLM 204. These figures are simplified diagrams for showing the different types of LLM 204 only, and those skilled in the art will understand that the LLM 204 may also comprise other functional modules that are not shown in these figures.

FIG. 5A shows an encoder-based LLM 204 comprising an encoder 222 which processes the input tokens 224 (which are the units (for example, words or characters partitioned from the prompt 206) and generates embeddings 226 (which are then used to generate the output 208). As those skilled in the art understand, embeddings are high-dimensional vectors encoding semantic contexts and relationships of data tokens.

Most popular LLMs 204 are decoder-based (or “decoder-only”) models. As shown in FIG. 5B, the LLM 204 may be a LLM comprising a decoder 232 which processes the input tokens 224 and generates output tokens 236 (which are then used to generate the output 208). More specifically, the decoder-only LLM 204 learns to produce a distribution for the next token in a sequence given past context as input.

As shown in FIG. 5C, the LLM 204 may be an encoder-decoder-based LLM comprising an encoder 222 which processes the input tokens 224 and generates embeddings 226, and a decoder 232 which generates output tokens 236 based on the embeddings 226 (which are then used to generate the output 208).

LLMs have significantly improved the state-of-the-art on various NLP tasks. These models, powered by advanced techniques such as the generative pre-trained transformer (GPT) architecture, can learn the distribution of their training set well enough to generate realistic text.

As described above, agentic software (agentware) powered by FMs with reasoning capabilities presents challenges, such as in the realm of observability. Herein, the term “agent” refers to a computer system or computing entity (such as a computing device or software component) that uses a foundation model to perform specific tasks by interacting with its environment, making decisions, and potentially adjusting its behavior based on inputs, all with minimum or even without human supervision.

Observability techniques applied to traditional software typically involve principles related to operational observability, such as monitoring metrics and system status through logs, traces, performance counters, and/or the like. Such methods are effective due to the direct traceability between the system's deterministic behavior and the development assets that are being executed, such as code snippets and predefined workflows. Developers can easily instrument such development assets (for example, code) to track execution flows, identify bottlenecks, and detect anomalies. Issues can be traced back to and addressed at the respective assets.

However, while operational observability has also shown its value for developers and operators of agentware by tracing model inference calls, tool usage, token consumption, and intermediate outputs at a system level, it falls short of providing adequate insights for diagnosing, debugging, and addressing issues in the implicit reasoning process of agents. Agents often operate with a high degree of independence, making decisions based on evolving and dynamically retrieved contexts, learned experiences, and interactions with other agents or environments. The underlying logic driving agent behavior is not traceable through conventional logs or performance counters, as the behavior of agents is not specified in code, but rather instructed through prompts and reasoned and planned by FMs that have extremely limited inherent explainability. As prompts and FMs are not instrumentable and do not produce deterministic or reproducible execution results, it is extremely challenging to pinpoint failures or understand why an agent behaves in a certain way. As such, new observability concepts and approaches are required that are capable of capturing not just system outputs, but also the cognitive-like reasoning processes of agents.

In prior art, FM observability platforms such as LangSmith, Traceloop, Weights and Biases, and others have already begun to offer support for tracking operational observability metrics for FMware. For example, the open-source OpenLLMetry package from Traceloop is designed to offer standard OpenTelemetry instrumentation for FM providers and vector databases. This enables developers to gain basic observability over their FMware, allowing them to monitor operational observability metrics such as prompts, token usage, and grounding accuracy over time.

Researchers have also made initial attempts to incorporate the reasoning paths of agents into frameworks. For example, academic paper entitled “STaR: Bootstrapping Reasoning with Reasoning” (denoted “REFERENCE1”), by Zelikman et al. focuses on generating reasonings that guide the foundation model towards the correct answer by reasoning backward from the solution, ultimately enhancing the model's accuracy. There has also been additional work in explaining the behavior of agents. Academic paper entitled “Explaining Agent Behavior with Large Language Models” (denoted “REFERENCE2”) by Zhang et al. proposes an approach to generate natural language explanations for an agent's behavior based only on observations of states and actions, agnostic to the underlying model representation.

While the aforementioned prior-art FM observability platforms provide valuable insights into operational metrics, they overlook the contextual factors and implicit reasoning paths of FMware and agents, and thus lack adequate insights to help developers assess the user-perceived quality and debug issues within reasoning paths of agents.

Additionally, these prior works from the research community do not address the need for observing an agents implicit reasoning process for the case of observability. REFERENCE1's goal is only to generate the reasoning that leads to the correct answer of the prompt, regardless of whether this generated reasoning actually reflect the agent's reasoning process. Also, REFERENCE2's work focuses on explaining agent behavior by monitoring the cause-and-effect actions (that is, when x happens, then y follows) of agents as a proxy to show their implicit reasoning paths. However, this is only inferring the reasoning paths by analyzing actions and outcomes of agents without interacting with the internal completion process, and so might not accurately capture the agent's reasoning process.

Thus, one cannot simply instruct agents in FMware to output their reasoning, because doing so inherently alters the completion. This is similar to the observer effect in quantum physics, where observing a system changes its state. When an agent is asked to explain its reasoning, it is no longer just completing its original task; it now has to simultaneously generate an explanation, which can shift its focus or introduce new biases into its responses. This alteration complicates the ability to assess the agent's original reasoning process in a pure, unmodified form, making it challenging to diagnose issues or understand the unobserved logic behind its actions.

Additionally, integrating reasoning into the output of FMs may not always be feasible due to the constraints imposed by downstream systems in FMware environments. These systems are often tightly coupled to the FM's outputs, expecting a strictly defined and structured format that aligns with their operational requirements. Introducing reasoning into the output could disrupt this structure, leading to potential incompatibilities and failure to meet the downstream system's expectations. As a result, the agent's ability to provide comprehensive explanations is limited, since deviating from the predefined format could compromise the primary functions of the FM. This presents a significant challenge in balancing the need for transparency in reasoning with the need to maintain operational efficiency and reliability in FM-powered systems.

In some embodiments, a cognitive observability method may be used for the reasoning of foundation model-powered agents to address the aforementioned challenges. This method enables the reasoning process of agents to be observed without affecting their behavior. In this method, a “surrogate agent” operates in parallel with an original agent of interest (denoted a “primary agent”) for observing its implicit reasoning process. In these embodiments, the surrogate agent is similar to, equivalent to, substantially the same as, or even a replica of the primary agent in that, given the same input prompt, the surrogate agent generates the same completion as the primary agent. In some embodiments, the surrogate agent may be set up with similar, equivalent, or substantially the same configuration as that of the primary agent to ensure that, given the same input prompt, the surrogate agent generates the same completion as the primary agent.

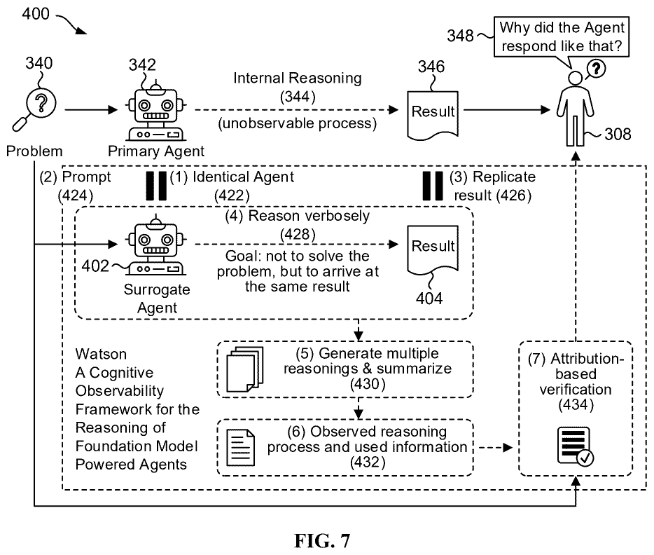

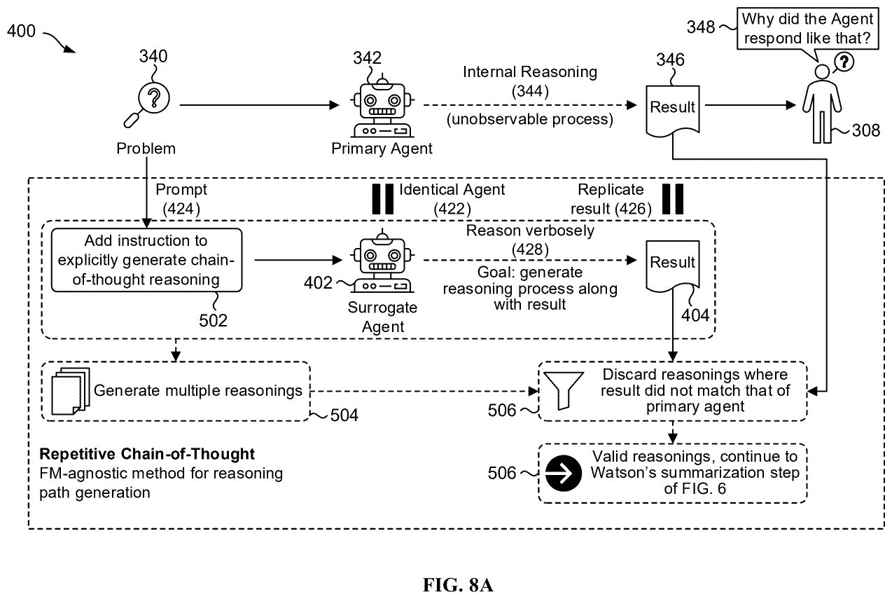

The goal of the surrogate agent is not to arrive at a “correct” completion, but rather to replicate the primary agent's completion, while also reasoning verbosely about its thought process for arriving at that outcome. As such, one can observe the implicit reasoning path used by the primary agent without affecting the original completion as a result of asking the agent to output its reasoning process. FIG. 6 shows an example.

As shown in FIG. 6, an agentware uses three agents 302, 304, and 306, including a conversational agent 302, a system design agent 304, and a code generation agent 306, to automate the process of turning human ideas into software systems. The conversational agent 302 gathers system requirements 312 by interacting with the user 308. These requirements 312 are passed to the system design agent 304, which creates a system design 314 based on the input 312. Finally, the code generation agent 306 takes the design 314 and generates the code 316 for the software. Together, these agents 302 to 306 streamline the development process from idea to execution.

In this example, a user 308 may interact with the conversational agent 302 and express the requirement 312 that the code should “minimize CPU usage costs in the cloud”. The conversational agent 302 passes this requirement 312 to the system design agent 304, which interprets the requirement 312 and makes an assumption 320 that the user has a limited budget for CPU resources but an unlimited budget for storage. Based on this assumption 320, the system design agent 304 designs (314) the system to allocate a single cloud CPU but one million storage buckets to optimize CPU costs. The code generation agent 306 then takes this design 314 and generates the corresponding code 316, efficiently implementing the system with minimal CPU usage but extensive use of storage. However, when reviewing the final program, the user 308 may be puzzled (318) by the design, for example, why the system is using one million storage buckets. The user 308 is unable to determine why this occurred because the implicit reasoning process of the system design agent 304 is not visible, leaving the underlying assumption 320 hidden.

In some embodiments, the cognitive observability method disclosed herein may be used in the agentware product to help users to observe the otherwise invisible reasoning path.

Clearly, by focusing on cognitive observability of foundation model-powered agents through the use of a surrogate agent, the cognitive observability method disclosed herein may be used a variety of technical fields, for example:
Cybersecurity and Threat Detection: The ability of observing implicit reasoning paths provided by the cognitive observability method disclosed herein may be extended to cybersecurity systems, particularly in threat detection and response. In this context, a “surrogate agent” may observe the decision-making processes of AI-driven security systems. Rather than detecting threats directly, the surrogate agent may monitor the internal reasoning and heuristic patterns of a security AI to identify anomalies, providing insights into how decisions are made and potentially revealing blind spots or biases.
Healthcare and Medical Diagnosis: The use of a surrogate agent to mirror reasoning in AI-powered diagnostic tools may provide transparency in critical healthcare applications. The surrogate agent may simulate the reasoning behind diagnoses while providing a verbose, interpretable explanation of why certain outcomes were suggested, aiding medical professionals in understanding the decision paths. This may lead to better trust and usability of AI in sensitive decision-making environments like healthcare.
Autonomous Systems (for example, self-driving cars): In autonomous vehicle technologies, the cognitive observability method disclosed herein may be used to improve transparency and accountability. A surrogate agent may observe and replicate the decision-making of a self-driving car's AI, offering detailed explanations for every maneuver and decision taken, thereby improving the ability to audit and verify these actions for safety and regulatory compliance.

In some embodiments, the cognitive observability method disclosed herein is structured around three primary features. First, the surrogate agent mirrors the configuration of the primary agent, allowing for the replication of the primary agent's behavior and ensuring similar performance among the two agents. Next, the cognitive observability method disclosed herein employs a mechanism for generating reasoning. Finally, the cognitive observability method disclosed herein ensures the generated reasonings are aligned with the targeted completion. Each of these features is described in detail below, with the assistance of an accompanying diagram shown in FIG. 7.

FIG. 7 shows a cognitive observability method 400, according to some embodiments of this disclosure. As shown, a user 308 may use a primary agent 342 to receive an input or prompt 340 (also denoted a “problem” or “question”), and conduct an internal reasoning 344 (which is an unobservable process) to obtain a result 346 to the problem 340.

To help the user 308 understand the reasoning 344 of the primary agent 342 and answer the user's question 348 such as “why did the agent respond like that?”, the cognitive observability method 400 uses a surrogate agent 402 (which in this example is an identical agent) (step 422) to receive the same prompt 340 (step 424) and a replicated result 404 (that is, a result same as the result 346) (step 426) to generate one or more reasonings (also called a “reasoning paths”).

More specifically, the surrogate agent 402 uses the prompt 340 and the replicated result 404 to perform verbose reasoning to generate a reasoning path (step 428). In these embodiments, the goal of the verbose reasoning 428 is not to solve the problem 340, but rather, is to obtain a reasoning that arrives at the same result, for facilitating the cognitive observability.

The cognitive observability method 400 may repeat step 428 to generate a plurality of reasoning paths, and summarize the generated reasoning paths (step 430). For example, a FM such as an LLM may be used at this step to parse the population of reasonings (that is, the generated reasoning paths) and generate a single “meta-reasoning”, which puts emphasis on common ideas that show up in many or all of the population of reasonings, while still mentioning any unique points that might show up in one or only a few of the reasonings from the population, for example, with indication that these points should not be treated with as much weight as the common points.

At step 432, the cognitive observability method 400 generates observed reasoning process and used information based on the reasonings and summarization generated at step 430. Then, the cognitive observability method 400 provides attribution-based verification to the user 308 (step 434).

Thus, the cognitive observability method 400 provides the following features:

### Mirroring Configuration of Primary Agent 342:

To ensure the surrogate agent 402 precisely replicates the primary agent's implicit reasoning process 344, the surrogate agent 402 maintains a mirrored (such as the same or equivalent) configuration (shown as “(1) identical agent” in step 422 of FIG. 7), which includes the FM architecture and key decoding parameters. By using the same FM, the surrogate agent 402 interprets the inputs with the same underlying capabilities as the primary agent 342. Furthermore, decoding parameters, such as temperature top_p, and/or the like, are identical between the two agents 342 and 402, as these parameters govern the determinism and creativity of the model's outputs, where even slight variations could lead to divergence in agent behavior.

### Generating Reasoning Paths:

As shown in FIG. 7, the cognitive observability method 400 in various embodiments may use various methods to let the surrogate agent 402 generate one or more reasoning paths (shown as “(4) reason verbosely” in step 428 of FIG. 7) that tie an input prompt 340 of a primary agent 342 (shown as (2) “prompt” in step 424 of FIG. 7) to the completion of the primary agent 342 (shown as “(3) replicate result” in step 426 of FIG. 7).

In some embodiments, the cognitive observability method uses the Fill-in-the-Middle (FIM) to generate the one or more reasoning paths at step 430 (via step 428).

As those skilled in the art understand, the FIM method is used for enabling causal decoder-based FMs to use both the prefix and suffix to infill a middle region of a prompt, primarily motivated for code completion applications. The FIM approach partitions a prompt into a prefix, middle, and suffix with the use of the special token of “<PRE>” for identifying the prefix, the special tokens of “<MID>” and “<EOM>” (that is, start-of-middle and end-of-middle) for identifying the middle, and the special token of “<SUF>” for identifying the suffix. During training, the FM uses the prefix and suffix content as the input prompt, and attempts to generate the content in the middle.

For example, the prompt:
The early bird catches the worm, but the second mouse gets the cheese. may be partitioned as:
<PRE> The early bird catches the worm, but <MID> the second mouse
<EOM><SUF> gets the cheese.

Then, the FIM uses the prefix (for example, “The early bird catches the worm, but”) and suffix (for example, “gets the cheese.”) to generate the middle (for example, “the second mouse”), which may be outputted in a “prefix-suffix-middle” format as follows:
<PRE> The early bird catches the worm, but <SUF> gets the cheese. <MID>
the second mouse <EOM>

In these embodiments, the surrogate agent uses the primary agent's prompt 340 as the prefix and the primary agent's completion 346 as the suffix to generate the middle as the primary agent's reasoning path. In a specific implementation, the output of the surrogate agent may be arranged as a “prefix-suffix-middle” format, that is:
<PRE> [the primary agent's prompt]<SUF> [the primary agent's completion]
<MID> [the middle as the primary agent's reasoning path]<EOM>
   wherein “[ ]” represents placeholder, which should be replaced by the actual content as indicated inside “[ ]”.

Thus, in this implementation, the surrogate agent 402 generates the one or more reasoning paths at step 430 (which may be used and/or summarized as the primary agent's reasoning), with the “<EOM>” token marking its end. To ensure the proper conduct of the FIM task, the cognitive observability method 400 in this implementation explicitly checks for the generation of the “<EOM>” token. As such, each reasoning path generated by the surrogate agent 402 is a verified implicit reasoning path for linking the primary agent's input prompt 340 and its corresponding completion 346. FIM is suitable for the goal of generating reasoning paths, and is suitable for AI methods such as FM that inherently support the FIM technique and can generate infilled completions.

### Verification of the Reasoning Consistency:

It is necessary to ensure that the reasoning generated by the surrogate agent 402 is aligned with the primary agent's completion 346 so that the surrogate agent's reasoning 428 reflects the implicit reasoning process 344 of the primary agent 342. For this purpose, the surrogate agent 402 generates multiple potential reasoning paths for extracting the mutual threads and/or recurring ideas or information (shown as “(5) generate multiple reasons and summarize” in step 430 of FIG. 7) from the reasoning paths. Doing so also allows for capturing different angles from which the primary agent 342 may have addressed the input prompt 340, providing a more comprehensive view of its implicit reasoning process 344 (shown as “(6) observed reasoning process and used information” in step 432 of FIG. 7).

After extracting the consistent threads and/or recurring ideas/information from the generated reasonings, their alignment is validated (shown as “(7) attribution-based verification” in step 434 of FIG. 7) with the input prompt 340 using, for example, PromptExp (which is a cross-granularity prompt explanation technique that calculates the importance of different components in the input prompt 340 (that is, the attributions of the input prompt 340) in influencing the agent's completion 346). In other words, the attribution-based verification 434 validates or confirms that the ideas represented by the components of the prompt 340 with the highest attributions are emphasized within the generated reasoning (for example, the extracted threads and/or ideas that are grounded in, based on, or generally generated from one or more components of the prompt 340 having the most important attributions (that is, the one or more most important prompt components, such as one or more components of the prompt 340 whose attribution importance values are greater than a predefined threshold, or the N “top” components of the prompt 340 (the N prompt components whose attributions are greater than those of other prompt components)).

For calculating these attributions, the input prompt 340 is tokenized to create a perturbed version of the input by removing one token at a time, effectively masking it. This perturbed prompt is then passed to the primary agent 342 for a new completion. To evaluate the importance of the masked input token, the probability differences among analogous tokens of the new completion and the completion corresponding to the original input prompt are calculated. A higher arithmetic mean of these differences results in a higher attribution value (that is, importance) for the masked input token, which in turn indicates its greater importance for the agent completion. Then, the token attributions are aggregated to different granularities of the prompt using, for example, the method in PromptExp.

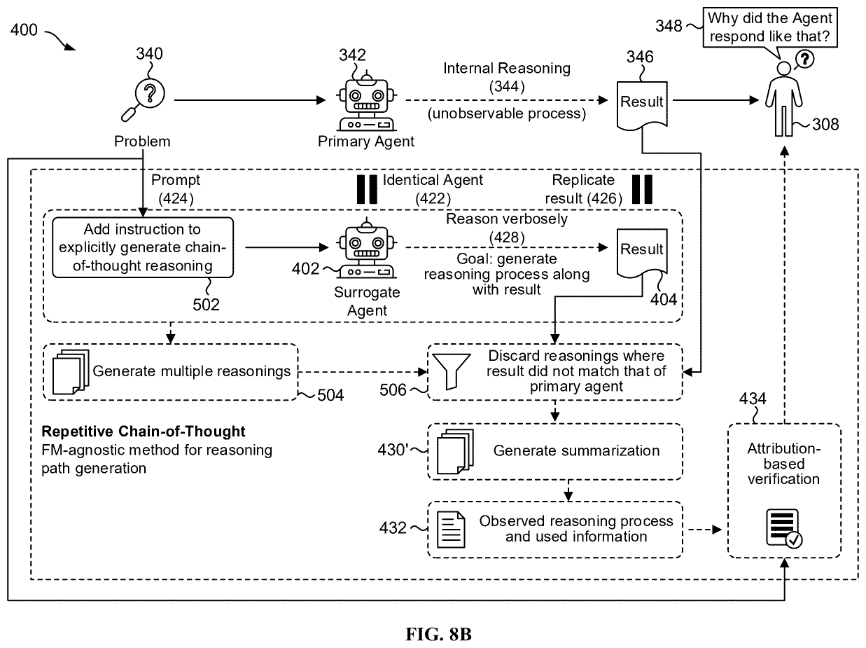

In some embodiments, the cognitive observability method 400 does not use the FIM method for reasoning generation. Instead, the cognitive observability method 400 in these embodiments uses a repetitive chain-of-thought (RepCoT) method for reasoning generation, which is not specific to FMs with FIM capability. FIG. 8A shows an example.

The cognitive observability method 400 in these embodiments is similar to that shown in FIG. 7 with the addition of the RepCoT method. Accordingly, the components and steps that are same as those shown in FIG. 7 are identified using same reference numerals. As shown in FIG. 8A, the cognitive observability method 400 comprises the following features:
Using a surrogate agent 402 that is identical to, the same as, or equivalent to the primary agent 342 (step 422).
Providing the surrogate agent 402 with the same input prompt 340 as the primary agent 342 (step 424), and providing the surrogate agent 402 with an additional instruction 502 to explicitly generate chain-of-thought reasoning in its completion 404.
Based on the input prompt 340 and the added instruction 502, the surrogate agent 402 performs verbose reasoning (step 428) for generating a plurality of reasonings 504.

To ensure alignment, any reasoning 504 generated by the surrogate agent 402 leading to an answer 404 different from the primary agent's final completion 346 is discarded (step 506). In other words, one or more reasonings 504 that match the primary agent's completion 346 are selected or otherwise maintained. This alignment step is important in RepCoT as it guarantees that the surrogate agent's reasoning 504 remains consistent with the primary agent's implicit reasoning process, ensuring that the surrogate agent 402 only captures the most relevant reasoning paths. This filtering process 506 minimizes discrepancies and ensures that the reasoning 504 being analyzed is closely tied to the primary agent's behavior.

After the filtering process 506, valid reasonings are kept (step 508) and the method 400 goes to the summarization and subsequent steps of FIG. 7. More specifically, as shown in FIG. 8B, after obtaining valid reasonings at step 508, the method 400 generates summarization (denoted 430′, which is part of step 430 shown in FIG. 7), and then generates observed reasoning process and used information based on the valid reasonings and the summarization of the corresponding reasoning paths (step 432). Then, the attribution-based verification is provided to the user 308 (step 434).

The cognitive observability method 400 in these embodiments may capture the reasoning paths of the surrogate agent 402, and consequently the implicit reasoning of the primary agent 342, without the necessity for their underlying FMs to support FIM.

In various embodiments, the cognitive observability methods 400 disclosed herein may be implemented as part of an agent observability platform. These would no doubt support operational observability techniques, but then also extend beyond traditional monitoring by providing deep interpretability into the cognitive processes of AI agents using the cognitive observability method. For example, if one wants to enhance their understanding of their agentware and ensure that the decision-making processes align with business objectives, they may use an agent observability platform that implements the cognitive observability method disclosed herein to instrument their agents to reveal the implicit reasoning patterns thereof.

The AI system and methods disclosed herein provide several advantages.

For example, by using the reasoning observability methods disclosed herein, the AI system and methods disclosed herein introduce a novel technique for observing an agent's implicit reasoning process.

The AI system and methods disclosed herein provide non-intrusive reasoning observation. The surrogate agent operates in parallel to the primary agent, mimicking its behavior but also generating a verbose reasoning process. This setup isolates the reasoning process from the actual task completion. Since the primary agent is unaware of the surrogate agent's role and continues to operate normally, its output remains unchanged. Thus, the technique allows us to observe reasoning without any interference with the original output.

The AI system and methods disclosed herein provide consistency and fidelity. The surrogate agent decouples reasoning from the FM's output, allowing the primary agent to produce its strictly formatted completion as required by downstream systems. Meanwhile, the surrogate agent performs a reasoning process independently, capturing the implicit decision-making path without integrating reasoning into the primary agent's output. This ensures that the primary agent continues to meet the strict formatting demands while the reasoning is still observable in parallel.

The AI system and methods disclosed herein provide enhanced debugging and interpretability. The AI system and methods disclosed herein enable enhanced observability by providing verbose reasoning paths, which can help in debugging, analyzing, and improving the primary agent's performance without modifying the underlying task completion.

By using the RepCoT method, the AI system and methods disclosed herein introduce another novel approach to reasoning generation by capturing the implicit reasoning of the primary agent without relying on FIM capabilities. Moreover, the RepCoT method prompts the surrogate agent to explicitly generate chain-of-thought reasoning while ensuring alignment with the primary agent's completion.

In some embodiments, the AI system may use internal state auditing for reasoning observability of agents. More specifically, the AI system may audit the internal states of the model during each step of the reasoning process. Instead of using an external agent, a tool may be embedded within the foundation model to log hidden states, attention weights, and activations as it processes input data. This internal auditing may create an “audit trail” that may later be reconstructed into an understandable reasoning process, allowing the observation of the model's implicit decision paths from its internal mechanics rather than through an external observe.

In some embodiments, the AI system may use counterfactual reasoning simulation for reasoning observability of agents. Instead of mirroring the primary agent's reasoning process with a surrogate agent, a counterfactual reasoning model may be employed. This approach may involve generating alternative outcomes by simulating “what-if” scenarios based on slightly modified inputs to the agent. By observing how small changes in the input or intermediate reasoning steps affect the final outcome, the AI system may infer the implicit decision paths of the agent. This may provide insights into the decision-making process without the need to directly replicate the completion. This method may be used as a proxy to generate the reasoning paths of agents.

### C. Acronyms, Abbreviations, and Definition of Some Terms

| Full Name | Acronym/Abbreviation/Initialism |
|---|---|
| Artificial Intelligence | AI |
| Foundation Model | FM |
| Fill-in-the-Middle | FIM |
| Repetitive Chain-of-Thought | RepCoT |

Some technical terms are defined as follows:
Foundation Model (FM): A class of AI models pre-trained on vast data across various domains, enabling them to develop a wide range of capabilities.
AIware: Artificial intelligence software, which is software powered by artificial intelligence.
FMware: Foundation model software, which is software powered by foundation models (which is a sub-category of AIware).
Agent: A computer system or computing entity (such as a computing device or software component) that uses a foundation model to perform specific tasks by interacting with its environment, making decisions, and potentially adjusting its behavior based on inputs.
Agentware: Software powered by agents (which is a sub-category of FMware)
Operational Observability: Observing and monitoring metrics and system status through logs, traces, performance counters, and/or the like.
Cognitive Observability: Observing and monitoring higher-level cognitive and linguistic aspects of the system of interest.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Although in above examples, the adaptive information retrieval method is performed by the computer network system 100, in some embodiments, no computer network system 100 is required, and the methods disclosed herein is performed by a single computing device 102 or 104.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method for generating reasoning of a first agent of a foundation model (FM), the method comprising:
using a second agent to replicate a first completion generated by the first agent corresponding to a prompt while reasoning a thought process of the first agent in generating the first completion from the prompt, for generating the reasoning of the first agent.

2. The computerized method of claim 1, wherein the second agent is same as or equivalent to the first agent, and/or has a same or equivalent configuration as the first agent.

3. The computerized method of claim 1, wherein said using the second agent to replicate the first completion generated by the first agent corresponding to the prompt while reasoning the thought process of the first agent in generating the first completion from the prompt comprises:
using the second agent to generate the reasoning of the first agent based on the prompt and the first completion; and
verifying consistency of the generated reasoning of the first agent.

4. The computerized method of claim 3, wherein said using the second agent to generate the reasoning of the first agent based on the prompt and the first completion comprises:
using the second agent to use a Fill-in-the-Middle (FIM) method to generate one or more reasoning paths as the reasoning of the first agent, based on the prompt and the first completion;
wherein an input of the FIM method has a prefix-middle-suffix structure, and comprises the prompt as a prefix and the first completion as a suffix, and each middle generated by the FIM method is one of the one or more reasoning paths.

5. The computerized method of claim 3, wherein said using the second agent to generate the reasoning of the first agent based on the prompt and the first completion comprises:
using the second agent to generate one or more chain-of-thought reasonings as the generated reasoning of the first agent based on the prompt;
wherein each of the one or more chain-of-thought reasonings leads to an answer matching the completion of the first agent.

6. The computerized method of claim 5, wherein said using the second agent to generate the one or more chain-of-thought reasonings as the generated reasoning of the first agent based on the prompt comprises:
using the second agent to generate a plurality of reasonings; and
selecting one or more of the plurality of reasonings that match the completion of the first agent.

7. A system comprising:
one or more non-transitory, computer-readable storage media; and
one or more processors functionally connected to the one or more non-transitory, computer-readable storage media;
wherein the one or more non-transitory, computer-readable storage media comprising computer-executable instructions; and
wherein the instructions, when executed, cause the one or more processors to perform the method of claim 1.

8. The system of claim 7, wherein the second agent is same as or equivalent to the first agent, and/or has a same or equivalent configuration as the first agent; and
wherein said using the second agent to replicate the first completion generated by the first agent corresponding to the prompt while reasoning the thought process of the first agent in generating the first completion from the prompt comprises:
using the second agent to generate the reasoning of the first agent based on the prompt and the first completion, and
verifying consistency of the generated reasoning of the first agent.

9. The system of claim 8, wherein said using the second agent to generate the reasoning of the first agent based on the prompt and the first completion comprises:
using the second agent to use a Fill-in-the-Middle (FIM) method to generate one or more reasoning paths as the reasoning of the first agent, based on the prompt and the first completion;
wherein an input of the FIM method has a prefix-middle-suffix structure, and comprises the prompt as a prefix and the first completion as a suffix, and each middle generated by the FIM method is one of the one or more reasoning paths.

10. The system of claim 8, wherein said using the second agent to generate the reasoning of the first agent based on the prompt and the first completion comprises:
using the second agent to generate one or more chain-of-thought reasonings as the generated reasoning of the first agent based on the prompt;
wherein each of the one or more chain-of-thought reasonings leads to an answer matching the completion of the first agent.

11. One or more non-transitory, computer-readable storage media comprising computer-executable instructions, wherein the instructions, when executed, cause one or more processors to perform the method of claim 1.

12. The one or more non-transitory, computer-readable storage media of claim 11, wherein the second agent is same as or equivalent to the first agent, and/or has a same or equivalent configuration as the first agent.

13. The one or more non-transitory, computer-readable storage media of claim 11, wherein said using the second agent to replicate the first completion generated by the first agent corresponding to the prompt while reasoning the thought process of the first agent in generating the first completion from the prompt comprises:
using the second agent to generate the reasoning of the first agent based on the prompt and the first completion; and
verifying consistency of the generated reasoning of the first agent.

14. The one or more non-transitory, computer-readable storage media of claim 13, wherein said using the second agent to generate the reasoning of the first agent based on the prompt and the first completion comprises:
using the second agent to generate one or more reasoning paths as the reasoning of the first agent, based on the prompt and the first completion.

15. The one or more non-transitory, computer-readable storage media of claim 14, wherein said using the second agent to generate the one or more reasoning paths as the reasoning of the first agent comprises:
using the second agent to use a Fill-in-the-Middle (FIM) method to generate the one or more reasoning paths as the reasoning of the first agent, based on the prompt and the first completion;
wherein an input of the FIM method has a prefix-middle-suffix structure, and comprises the prompt as a prefix and the first completion as a suffix, and each middle generated by the FIM method is one of the one or more reasoning paths.

16. The one or more non-transitory, computer-readable storage media of claim 13, wherein said using the second agent to generate the reasoning of the first agent based on the prompt and the first completion comprises:
using the second agent to generate one or more chain-of-thought reasonings as the generated reasoning of the first agent based on the prompt;
wherein each of the one or more chain-of-thought reasonings leads to an answer matching the completion of the first agent.

17. The one or more non-transitory, computer-readable storage media of claim 16, wherein said using the second agent to generate the one or more chain-of-thought reasonings as the generated reasoning of the first agent based on the prompt comprises:
using the second agent to generate a plurality of reasonings; and
selecting one or more of the plurality of reasonings that match the completion of the first agent.

18. The one or more non-transitory, computer-readable storage media of claim 13, wherein said verifying the consistency of the generated reasoning of the first agent comprises:
extracting consistent threads and/or recurring ideas from the generated reasoning of the first agent; and
verifying alignment between the extracted threads and ideas and the prompt.

19. The one or more non-transitory, computer-readable storage media of claim 18, wherein said verifying the alignment between the extracted threads and ideas and the prompt comprises:
calculating an importance of each of one or more attributions of the prompt in influencing the first completion; and
validating that extracted threads and/or ideas comprise one or more of the attributions of the prompt whose importance is greater than a predefined threshold.

20. The one or more non-transitory, computer-readable storage media of claim 19, wherein said calculating the importance of each of the one or more attributions of the prompt in influencing the first completion comprises:
(i) tokenizing the prompt to obtain a tokenized prompt having a plurality of tokens;
for each of the plurality of tokens of the tokenized prompt:
(ii-1) removing the token from the tokenized prompt to obtain a perturbed prompt,
(ii-2) using the first agent to generate a second completion based on the perturbed prompt,
(ii-3) calculating probability differences among analogous tokens of the second completion and the first completion,
(ii-4) repeating steps (ii-2) and (ii-3) for one or more times, and
(ii-5) calculating an average of the calculated probability differences as the importance of the removed token.
